(19) United States
(12) Patent Application Publication
(10) Pub. No.: US 2026/0336149 A1
(43) Pub. Date: Oct. 29, 2026

(54) KNIFE HOLDER WITH REPLACEABLE BLADE FOR PET FOOD EXTRUSION

(71) Applicant: Robert Carroll Marotz, Perham, MN (US)

(72) Inventor: Robert Carroll Marotz, Perham, MN (US)

(21) Appl. No.: 19/188,457

(22) Filed: Apr. 24, 2025

Related U.S. Application Data
(60) Provisional application No. 63/562,477, filed on Mar. 7, 2024.

(51) Int. Cl. B26D 7/26; A23N 17/00; B26D 1/00

(52) U.S. Cl. CPC B26D 7/2614; A23N 17/005; B26D 1/0006; B26D 2001/002; B26D 2001/0053; B26D 2210/02

(57) ABSTRACT

A heavy-duty knife holder assembly is provided for use in industrial food processing applications, including pet food extrusion. The assembly includes an L-shaped holder body machined from solid billet steel and configured to receive a replaceable blade. An attachment slot is formed in the body to securely seat the blade, which includes a sharpened cutting edge. The blade is fastened to the holder using a plurality of fasteners, such as countersunk screws, which pass through the blade and into threaded bores in the holder body. The modular design allows for the blade to be removed, resharpened, or replaced without discarding the entire assembly. Alternative embodiments may include various blade materials, fastener types, and corrosion-resistant coatings. The invention provides improved durability, cost-efficiency, and adaptability compared to conventional non-replaceable cutting tools.

### CROSS-REFERENCE TO RELATED APPLICATION

This application claims the benefit of priority of U.S. provisional application No. 63/562,477, filed Mar. 7, 2024, the contents of which are herein incorporated by reference.

### BACKGROUND OF THE INVENTION

The food industry continues to depend heavily on cutting tools, particularly knives, for an expansive array of processing and preparation tasks. From butchering meats to slicing vegetables and preparing specialty ingredients, knives are integral to maintaining efficiency and precision in food production environments. Over time, various designs and materials have been introduced in an attempt to meet the growing demands of high-volume kitchens and processing plants. Among these, fixed-blade knives, including L-shaped configurations, have remained a mainstay due to their simplicity and perceived durability. Despite incremental advancements, the current landscape of food industry knives has failed to adequately address several operational and ergonomic challenges.

A significant limitation of many knives used in commercial food processing is the lack of modularity. The majority of knives in circulation today feature non-replaceable blades that are either welded or machined from a single block of metal. While such designs may initially offer structural integrity, they become a liability when the blade dulls, chips, or corrodes. In such cases, the entire knife must be discarded or professionally serviced, resulting in unnecessary downtime, increased costs, and safety risks associated with using compromised tools. Furthermore, a one-piece design restricts users from customizing or adapting the knife for specific applications, leading to inefficiencies in diverse work environments.

The issue is compounded by the limited availability of blade materials tailored for specific food processing tasks. Although stainless steel remains a popular choice for its corrosion resistance, it does not always deliver the hardness or edge retention required in more demanding settings. High-carbon steel blades, while superior in these respects, are often susceptible to rust and require careful maintenance. Moreover, sourcing specialty blades that can withstand extreme temperatures or corrosive substances proves difficult, especially when integrated into non-modular knife systems. As a result, food industry professionals are frequently forced to compromise on performance, safety, or cost-effectiveness.

Therefore, the need exists for a knife holder with a replaceable blade that can accommodate various blade materials and configurations, providing greater flexibility, durability, and efficiency in food processing applications.

### SUMMARY OF THE INVENTION

The present invention is directed to a heavy-duty L-shaped knife holder assembly designed for use in food industry applications, particularly those involving high wear and demanding environments such as pet food extrusion. In a preferred embodiment, the invention comprises a robust body machined from solid billet steel, which features an attachment slot designed to receive a replaceable blade. The blade includes a cutting edge and is secured to the holder by a set of blade fasteners, such as countersunk screws.

This invention addresses key problems in the industry related to durability, versatility, and supply limitations of conventional one-piece knives, which are not easily replaceable or adaptable to different materials. Unlike fixed-blade tools, this assembly allows for quick replacement or sharpening of the blade without replacing the entire knife, thereby extending tool life and reducing downtime. Additionally, it supports the use of various blade materials suited to specific processing needs, enhancing adaptability and performance.

The replaceable blade feature significantly reduces waste and operational cost while allowing end users to switch between blade types—such as high-carbon, stainless, or composite materials—based on the task at hand. The fasteners ensure a secure yet removable connection, enabling maintenance and customization without compromising performance.

Overall, the invention delivers a rugged, modular cutting solution tailored for industrial food processing, offering a practical improvement over existing L-shaped knives by combining durability, replaceability, and material flexibility into a single integrated system.

These and other features, aspects and advantages of the present invention will become better understood with reference to the following drawings, description and claims.

### BRIEF DESCRIPTION OF THE DRAWINGS

FIG. 1 is a top left perspective view of a knife holder with a replaceable blade for use in connection with the food industry in accordance with a preferred embodiment of the present invention;

FIG. 2 is a bottom right perspective view of a knife holder with a replaceable blade for use in connection with the food industry in accordance with a preferred embodiment of the present invention;

FIG. 3 is a top view of a knife holder with a replaceable blade for use in connection with the food industry in accordance with a preferred embodiment of the present invention;

FIG. 4 is a side view of a knife holder with a replaceable blade for use in connection with the food industry in accordance with a preferred embodiment of the present invention; and

FIG. 5 is an exploded view of a knife holder with a replaceable blade for use in connection with the food industry in accordance with a preferred embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention relates to a knife holder with a replaceable blade for use in the food industry, particularly in the pet food extrusion process. The invention is designed to provide a versatile and efficient cutting tool that can be easily replaced when worn or damaged.

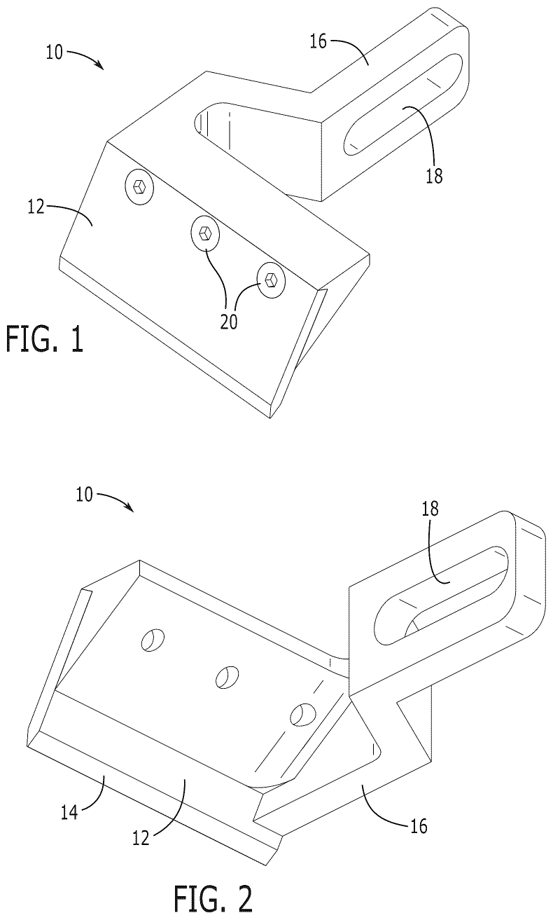

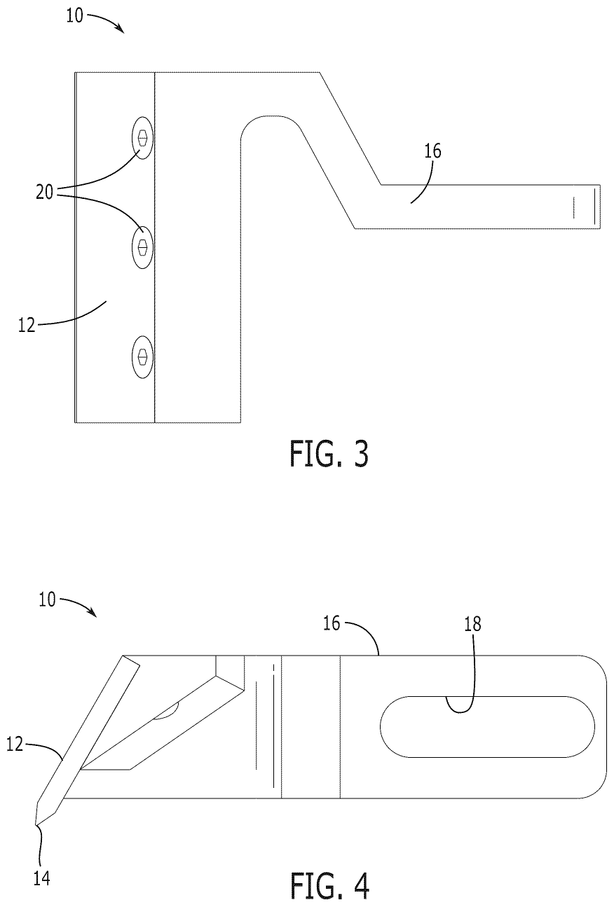

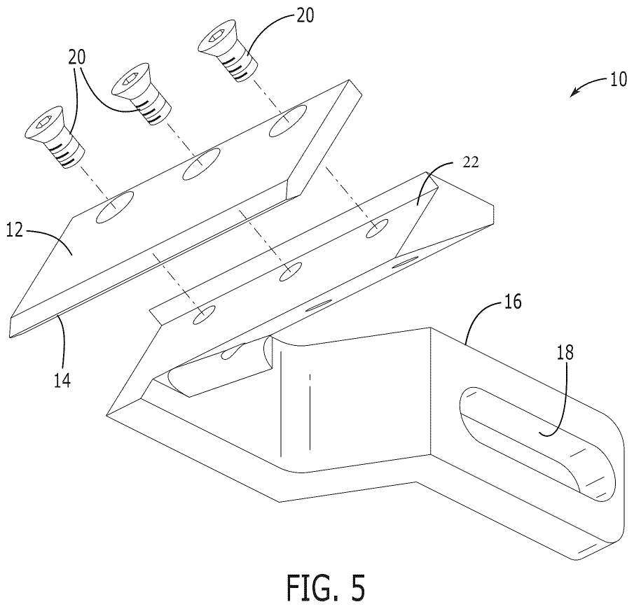

Referring now to the accompanying drawings FIGS. 1-5, the present invention is directed to a knife holder assembly 10 comprising an L-shaped holder body 16 configured to receive and secure a replaceable blade 12. The components are arranged to provide a robust, modular cutting tool suitable for industrial applications such as the pet food extrusion process and other food production environments.

The L-shaped body 16 serves as the primary support structure and, in a preferred embodiment, is machined from solid billet steel for enhanced strength and durability. The L-shaped configuration includes a horizontal section designed for mounting and a vertical section that provides structural support for the blade. This orientation enables precise positioning of the cutting edge 14 for effective slicing or shearing of material as the assembly rotates within a processing fixture.

An attachment slot 18 is formed into the body 16 and extends along a portion of the handle of the L-shaped body. A blade mounting area 22 is formed into the opposite end of body 16 and is dimensioned to receive the replaceable blade 12 in a seated configuration. The mounting area 22 ensures proper alignment of the blade and restricts unwanted lateral or axial movement during operation. The blade 12 is configured to fit within the mounting area 22 such that its cutting edge 14 is exposed at a desired angle relative to the plane of the holder body. The cutting edge 14 may be sharpened to a precise relief angle, such as 3 degrees, to optimize performance.

In various embodiments of the invention, the cutting edge 14 of the replaceable blade 12 may be configured in different geometries depending on the intended application. While a straight, sharpened edge with a ground relief angle is suitable for general-purpose slicing and shearing, alternative edge profiles may be utilized to improve performance for specific food materials or cutting tasks.

In one embodiment, the cutting edge 14 may be formed as a serrated edge, which includes a series of evenly spaced teeth or notches along the length of the blade. A serrated edge may be beneficial for processing fibrous materials, frozen food products, or items with tough outer surfaces and softer cores, as the teeth assist in initiating cuts and maintaining grip on the material during slicing.

In another embodiment, the cutting edge 14 may include a scalloped profile, in which curved recesses alternate with sharpened points. This configuration can provide a smoother, cleaner cut in delicate or moist materials such as cooked meats or bakery items, reducing tearing and residue buildup on the blade.

The edge may also be configured with a double-bevel or compound grind, offering a combination of strength and sharpness suitable for high-frequency use. Alternatively, a hollow-ground edge may be employed to reduce drag and enhance cutting precision in soft or sticky materials.

Additionally, the blade edge may be asymmetrically ground for specific applications where the cutting action is directional or where pressure needs to be concentrated on one side. In embodiments where cleanliness and sanitation are critical, the edge may be mirror-polished or treated with a non-stick coating to reduce residue adhesion and facilitate cleaning.

Each of these edge configurations may be formed integrally during the blade manufacturing process or applied post-machining via grinding, honing, or other edge-forming techniques. The modular design of the knife holder assembly allows users to select and install blades with edge geometries best suited to their particular processing needs, providing a high degree of flexibility and operational efficiency.

To secure the blade 12 to the mounting area 22 of body 16, the assembly includes a plurality of blade fasteners 20. In the illustrated embodiment, three countersunk flat-head screws are used to pass through corresponding holes in the blade and into tapped bores in the holder body. These fasteners are torqued to a defined specification (e.g., 35 inch-pounds) to ensure the blade remains fixed during high-speed operation. The countersunk design ensures a flush fit with the blade surface, minimizing snag points and ensuring uniform pressure distribution along the blade.

In alternative embodiments, the blade fasteners 20 may be implemented as hex-head bolts, threaded pins, tool-less latch mechanisms, or quick-release cam locks, offering enhanced convenience or tamper-resistance depending on the operational context. Captive fasteners may also be used, allowing the fasteners to remain attached to the holder body when not engaged with the blade, which reduces the risk of loss and speeds up maintenance procedures.

The replaceable blade 12 may be fabricated from hardened spring steel, such as 1075, or alternative materials depending on the application requirements. These materials include but are not limited to high-carbon tool steel for superior edge retention, stainless steel alloys for corrosion resistance, ceramic composites for inert food contact surfaces, and titanium alloys for strength-to-weight optimization. Each of these materials may be sharpened to form the cutting edge 14 and may include coatings or treatments to improve wear resistance and sanitation compliance.

In some embodiments, corrosion-resistant coatings may be applied to the blade 12, fasteners 20, or both. Suitable coatings include electroless nickel plating, passivated stainless finishes, or food-safe ceramic layers to protect against moisture, acidic ingredients, and repeated washdown cycles.

Once assembled, the knife holder assembly 10 may be installed into a rotary fixture commonly used in food processing or extrusion equipment. The dimensions and geometry of the L-shaped body 16 are compatible with standard machine fittings, allowing the assembly to serve as a direct replacement for traditional, non-replaceable knife tools. This configuration enables users to re-sharpen or swap the blade 12 without discarding the entire tool, providing a cost-effective, environmentally sustainable, and operationally flexible solution.

Although specific embodiments have been described herein, it will be understood that the arrangement, orientation, and materials of the components may be modified without departing from the scope of the invention as defined in the appended claims.

What is claimed is:

1. A knife holder assembly comprising:
a body having an L-shaped configuration;
a blade mounting area formed in the body;
a replaceable blade configured to be received within the blade mounting area;
wherein the replaceable blade includes a cutting edge; and
a plurality of blade fasteners configured to removably secure the replaceable blade to the blade mounting area.

2. The knife holder assembly of claim 1, wherein the body is machined from solid billet steel.

3. The knife holder assembly of claim 1, wherein the replaceable blade is made from hardened spring steel.

4. The knife holder assembly of claim 1, wherein the replaceable blade is further defined by a leading cutting edge having a relief angle.

5. The knife holder assembly of claim 1, wherein the plurality of blade fasteners comprises three countersunk screws.

6. The knife holder assembly of claim 1, wherein the blade mounting area is formed along a longitudinal surface of the L-shaped body and dimensioned to align the replaceable blade in a fixed cutting orientation.

7. The knife holder assembly of claim 1, wherein the L-shaped configuration of the body comprises a horizontal mounting section and a vertical cutting support section.

8. The knife holder assembly of claim 1, wherein the blade fasteners are torqueable fasteners configured to secure the blade under a predetermined torque value.

9. The knife holder assembly of claim 1, wherein the replaceable blade includes at least one aperture aligned with a corresponding bore in the body for receiving the blade fasteners.

10. The knife holder assembly of claim 1, wherein the assembly is configured to be mounted in a rotary cutting fixture used in a food extrusion process.

11. The knife holder assembly of claim 1, wherein the blade fasteners are selected from the group consisting of: hex-head bolts, quick-release cam locks, threaded pins, and tool-less latch mechanisms.

12. The knife holder assembly of claim 1, wherein the replaceable blade is formed from a material selected from the group consisting of: high-carbon tool steel, stainless steel alloy, ceramic composite, and titanium alloy.

13. The knife holder assembly of claim 1, wherein the blade fasteners are captive fasteners configured to remain attached to the body when disengaged from the blade.

14. The knife holder assembly of claim 1, wherein the fasteners are configured with tamper-resistant heads to prevent unintentional removal during operation.

15. The knife holder assembly of claim 1, wherein the blade and fasteners are coated with a corrosion-resistant finish suitable for high-moisture or caustic food processing environments.

16. The knife holder assembly of claim 1, wherein the cutting edge of the replaceable blade is a serrated edge comprising a series of alternating teeth and notches configured to enhance cutting performance on fibrous or tough materials.

17. The knife holder assembly of claim 1, wherein the cutting edge of the replaceable blade has a scalloped profile, including a series of concave recesses alternating with sharpened points to reduce tearing and improve slicing of soft or moist food products.

18. The knife holder assembly of claim 1, wherein the cutting edge of the replaceable blade is configured with a hollow-ground or compound bevel, adapted to reduce cutting resistance and maintain a sharper edge during extended use.
